(19) United States
(12) Patent Application Publication
(10) Pub. No.: US 2026/0203534 A1
(43) Pub. Date: Jul. 16, 2026

(54) DYNAMIC PROJECTION MAPPING USING TAG ARRAY

(71) Applicant: Universal City Studios LLC, Universal City, CA (US)

(72) Inventor: David Gerard Majdali, Orlando, FL (US)

(21) Appl. No.: 19/025,762

(22) Filed: Jan. 16, 2025

(51) Int. Cl. G06K 7/10; G03B 21/12

(52) U.S. Cl. CPC G06K 7/10099; G03B 21/12; G06K 7/10306

(57) ABSTRACT

A dynamic projection mapping system includes a projector configured to project visible light, and one or more radiofrequency (RF) readers configured to detect multiple RF tags of a prop. The dynamic projection mapping system also includes a processing system having one or more processors. The dynamic projection mapping system further includes memory storing instructions that, when executed by the processing system, causes the processing system to determine a position of the prop in an environment based on signals received from the one or more RF readers based on detection of the multiple RF tags, and instruct the projector to provide the visible light onto the prop based on the position of the prop.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Entertainment venues contain, among many other attractions, animated figures to entertain guests. In some cases, an animated figure may have an internally-positioned projector that projects images through a semi-transparent surface of the animated figure. However, this configuration may generate an unrealistic backlight or glow from a perspective of the guests viewing the animated figure. Further, an animated figure may be brought to life by projection mapping, which may utilize an externally-positioned projector to project images onto a surface of the animated figure. However, the projection mapping may use a canned or fixed set of images that are projected based on preprogrammed movements of the animated figure.

### SUMMARY

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In an embodiment, a dynamic projection mapping system includes a projector configured to project visible light, and one or more radiofrequency (RF) readers configured to detect multiple RF tags of a prop. The dynamic projection mapping system also includes a processing system with one or more processors. The dynamic projection mapping system further includes memory storing instructions that, when executed by the processing system, causes the processing system to determine a position of the prop in an environment based on signals received from the one or more RF readers based on detection of the multiple RF tags, and instruct the projector to provide the visible light onto the prop based on the position of the prop.

In an embodiment, a dynamic projection mapping system includes a prop with multiple radiofrequency (RF) tags, one or more RF readers configured to detect the multiple RF tags, and a projector configured to project imagery. The dynamic projection mapping system also includes a processing system with one or more processors. The dynamic projection mapping system further includes memory storing instructions that, when executed by the processing system, causes the processing system to determine a position of the prop relative to a common coordinate system for an environment based on signals received from the one or more RF readers based on detection of the multiple RF tags, and instruct the projector to project the imagery onto the prop based on the position of the prop relative to the common coordinate system for the environment.

In an embodiment, a method of operating a dynamic projection mapping system includes receiving, at one or more processors, signals from one or more ultra-wideband (UWB) readers based on detection of multiple UWB tags of a prop by the one or more UWB readers. The method also includes determining, using the one or more processors, a position of the prop in an environment based on the signals from the one or more UWB readers and known positioning of the one or more UWB readers in the environment. The method further includes instructing, using the one or more processors, a projector to project imagery onto an external surface of the prop based on the position of the prop in the environment.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of a projection mapping system, in accordance with an embodiment of the present disclosure;

FIG. 2 is a block diagram of the projection mapping system of FIG. 1, in accordance with an embodiment of the present disclosure;

FIG. 3 is a front view of a portion of an animated figure with a tag array and with human-like facial features projection mapped onto the animated figure using the projection mapping system of FIG. 1, in accordance with an embodiment of the present disclosure;

FIG. 4 is a front view of a portion of an animated figure with a tag array and with animal-like facial features projection mapped onto the animated figure using the projection mapping system of FIG. 1, in accordance with an embodiment of the present disclosure;

FIG. 5 is a cross-sectional schematic side view of a portion of an animated figure with a tag array, such as the portion of the animated figure of FIGS. 3 or FIG. 4 in accordance with an embodiment of the present disclosure; and

FIG. 6 is a flow diagram of a method of operating a projection mapping system, such as the projection mapping system of FIG. 1, in accordance with an embodiment of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” “having,” and “based on” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Present embodiments are directed to a projection mapping system (e.g., dynamic projection mapping system; media system), which may be implemented in an environment. For example, the environment may include an entertainment venue, an amusement park, a ride attraction, an amusement attraction, a path or a queue area, a sports stadium, a theatre, a school, a restaurant, a hotel, and so forth. The projection mapping system may include a media control system that includes a projector to project images onto an external surface of a prop, such as an animated figure. By projection mapping onto the external surface of the animated figure, the animated figure may appear more lifelike (e.g., as compared to certain animated figure systems that internally project images through a semi-transparent surface of an animated figure, which generates an unnatural or ethereal glowing appearance). As discussed herein, the projection mapping system also leverages tracking to dynamically generate and provide images onto the external surface of the animated figure.

The animated figure may include (e.g., be coupled to; support; house) a tag array with multiple tags (e.g., antennas; radiofrequency (RF) tags), such as multiple ultra-wide band (UWB) tags. Further, the tag array may communicate with (e.g., be read by) one or more readers (e.g., anchors; RF readers), such as UWB readers. For example, the multiple tags may transmit respective RF signals (e.g., electromagnetic radiation), which may be received at the one or more readers. The one or more readers may generate respective signals (e.g., reader signals) indicative of receipt of the respective RF signals at the one or more readers, and the one or more readers may provide the respective signals to a controller (e.g., processing system; computing system). The controller may process the respective signals to determine a position (e.g., position data; current position) for the animated figure, wherein the position for the animated figure includes location and orientation (e.g., three-dimensional position, including x, y, and z coordinates). Further, the controller may process the respective signals to determine the position for the animated figure over time, wherein the position for the animated figure over time reflects or indicates movement of the animated figure. Accordingly, as used herein, “the position” for the animated figure may refer to the location, the orientation, and/or the movement of the animated figure. Further, “the position” for the animated figure may generally indicate a pose for the animated figure and/or changes to the pose for the animated figure.

It should be appreciated that the controller may utilize any suitable algorithms and/or processing techniques to process the respective signals to determine the position for the animated figure. For example, the controller may measure and/or evaluate phase differentials between the respective RF signals to determine the position for the animated figure. Additionally or alternatively, as one example, the controller may measure and/or evaluate timing information (e.g., time of arrival) for the respective RF signals to determine the position for the animated figure.

Advantageously, the media control system may dynamically generate and fit imagery (e.g., projected images) onto the external surface of the animated figure based on the position of the animated figure. Further, the media control system may dynamically generate and fit the imagery onto the external surface of the animated figure at a realistic framerate that emulates live characters, such as by presenting textures, colors, and/or moving elements that appear to be indistinguishable from the animated figure. In an embodiment, the media control system may operate independently of the animated figure (e.g., by not relying on position, velocity, and/or acceleration information from devices, such as sensors and/or actuators, coupled to the animated figure).

In an embodiment, the media control system may generate and update a skeletal model of the animated figure based on the position of the animated figure. The skeletal model generally represents moveable portions of the animated figure, and is dynamically updated to represent (e.g., mimic; correspond to; match) the position of the animated figure or portions thereof. The media control system therefore utilizes the skeletal model to generate the imagery for projection that precisely suits the position.

As discussed herein, a calibration may be carried out to align and to coordinate the media control system and the tracking system. The calibration may be done during setup, such as via placing the projector and the one or more readers at fixed positions in the environment. The calibration may establish a shared coordinate system with a shared origin point. Thus, the tracking system may determine the position of the animated figure relative to the shared coordinate system, and the media control system may provide the imagery according to the position of the animated figure relative to the shared coordinate system. In an embodiment, the projector of the media control system and the one or more readers of the tracking system may be at fixed, known positions relative to one another via mounting the projector and the one or more readers to a common frame. In this way, any displacement of the projector directly affects the one or more readers, and vice versa.

While certain examples presented herein refer to an animated figure to facilitate discussion, it should be appreciated that this term is intended to broadly cover any prop that may move within the entertainment venue and/or that may be projected onto via the media control system. Generally, it should be considered that the techniques disclosed herein may be applied to project onto any prop (e.g., object; structure; show action equipment [SAE]). For example, the prop may be a full animated robotic figure. As another example, the prop may be formed by one or more objects (e.g., simpler than a full animated robotic figure) that are moved around via complex SAE. Furthermore, regardless of its structure, the prop may represent a character (e.g., a human-like character, an animal-like character) or may not represent a character (e.g., an inanimate object, such as a building, furniture, waterfall).

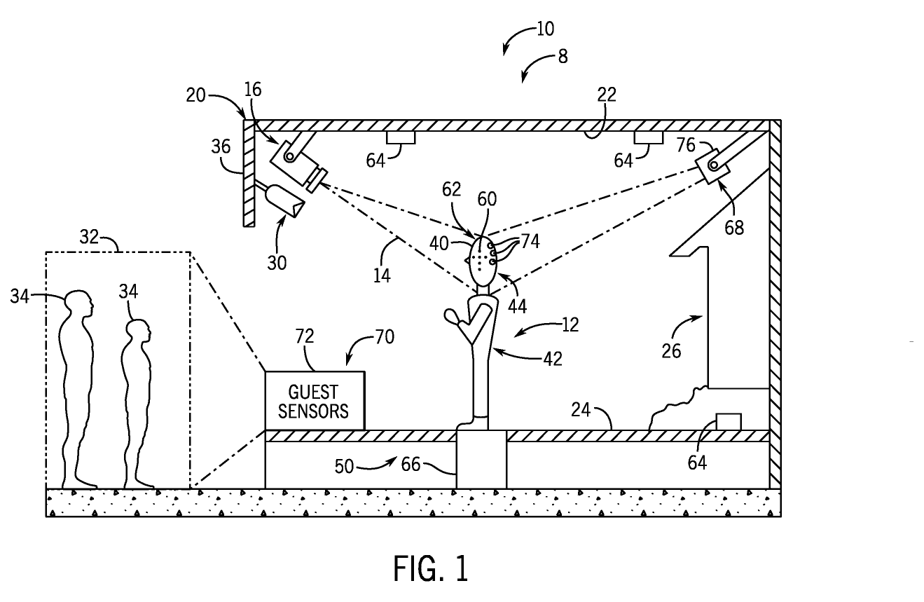

FIG. 1 illustrates an embodiment of a projection mapping system 8 (e.g., dynamic projection mapping system; media system) that may be used in an environment 10. As shown, a prop, which is shown and referred to herein as an animated FIG. 12 to facilitate discussion, may be positioned in the environment 10. A projector 16 (e.g., external projector, optical projector with lens) may project imagery 14 (e.g., projected images; content) onto the animated FIG. 12. The projector 16 may be part of a media control system 20 (e.g., media control system).

As shown, the environment 10 may be a show set having a stage ceiling 22, a stage floor 24, and/or scenery objects 26 disposed between the stage ceiling 22 and the stage floor 24. The show set may also include any suitable stage lighting devices 30, such as the illustrated lighting instruments or devices. From a guest area 32 of the environment 10, one or more guests 34 may view and/or interact with the animated FIG. 12. Although illustrated as within a stage-type environment, it should be understood that the projection mapping system 8 may be utilized to entertain the one or more guests 34 in any suitable environment, such as an entertainment venue, an amusement park, a ride attraction, an amusement attraction, a path or a queue area, a sports stadium, a theatre, a school, a restaurant, a hotel, and so forth.

Notably, the projector 16 is external to the animated FIG. 12, thereby enabling an enclosed volume within the animated FIG. 12 to be utilized to house components other than the projector 16, such as certain actuation systems (e.g., one or more actuators, such as electric, hydraulic, and/or pneumatic actuators), calibration components (e.g., one or more light emitters), sensing components (e.g., inertial measurement units), and/or computing components (e.g., one or more processors). In an embodiment, the projector 16 may be disposed in front of the animated FIG. 12 and obstructed from sight of the one or more guests 34 by an overhang 36 of the stage ceiling 22. Regardless of the position of the projector 16, the projector 16 may direct the imagery 14 onto an external surface 40 of a body 42 (e.g., structure; housing; flexible skin) of the animated FIG. 12. For example, the projector 16 may direct the imagery 14 onto the external surface 40 that is part of a head portion 44 of the body 42 of the animated FIG. 12. The media control system 20 may therefore deliver realistic and engaging textures to the head portion 44, thereby providing an immersive and interactive experience to the one or more guests 34.

The animated FIG. 12 may be part of a motion control system 50 (e.g., prop control system), which may operate independently of the media control system 20. For example, the motion control system 50 may leverage interactive data to dynamically update the animated FIG. 12. It should be understood that the motion control system 50 may instruct one or more actuators to adjust the animated FIG. 12 and/or to adjust any other suitable components of the environment 10 that may be viewable to the one or more guests 34. For example, the motion control system 50 may control an actuatable motion device 66 (e.g., actuatable motion base) that is physically coupled to and/or supports the animated FIG. 12. The actuatable motion device 66 may be any suitable motion-generating assembly that may move (e.g., translate, rotate) the animated FIG. 12 laterally, longitudinally, and/or vertically, for example. Furthermore, it should be appreciated that the actuatable motion device 66 may be or include a suspension system and/or flying system that is coupled to the animated FIG. 12 from above the stage floor 24.

The animated FIG. 12 may include (e.g., be coupled to; support; house) multiple tags 60 (e.g., antennas), such as multiple ultra-wide band (UWB) tags (e.g., emit a UWB signal, such as an RF signal with a bandwidth greater than 20 percent of its center frequency and/or with a bandwidth greater than 500 megahertz (MHz); a bandwidth within a range of 3.1 to 10.6 gigahertz (GHz), 4 to 8 GHz, or 6 to 7 GHz). The multiple tags 60 may be arranged as a tag array 62, such as with the multiple tags 60 spaced apart from one another in a known configuration relative to one another (e.g., with a known layout, including relative positions and distances between the multiple tags 60). For example, the multiple tags 60 may be supported on a frame, such as an internal frame of the animated FIG. 12, in the known configuration. Further, the multiple tags 60 may be arranged to extend in two-dimensions or in three-dimensions (e.g., not in a linear row; in a cross-shape or an x-shape; distributed or spaced related to one another along at least two of an x-axis, a y-axis, or a z-axis, located on different planes). In addition, the multiple tags 60 are in a known arrangement relative to the body 42 of the animated FIG. 12 (e.g., relative to the external surface 40, which receives and/or displays the imagery 14). Further, each of the multiple tags 60 may store and/or communicate a respective unique tag identifier (e.g., also referred to herein as “tag identifier”). Thus, each of the multiple tags 60 (and the respective unique tag identifier) is associated with a known position within the animated FIG. 12 as part of the known configuration of the tag array 62, as well as the known arrangement relative to the body 42 of the animated FIG. 12. For example, a particular tag of the multiple tags 60 may be positioned at specific coordinates in or on the animated FIGS. 12, such as on an internal frame or embedded in a material at a forehead of the animated FIG. 12, and this location may be indicated by a respective unique tag identifier for the particular tag of the multiple tags 60.

In an embodiment, the multiple tags 60 may be enclosed within the body 42 of the animated FIG. 12, such that the multiple tags 60 are not visible to the one or more guests 34 (e.g., not visible through the external surface 40 of the animated FIG. 12; hidden from view by the external surface 40 of the animated FIG. 12). The body 42 of the animated FIG. 12 may be formed with certain materials (e.g., non-conductive materials, such as elastomer; flexible skin) to overlay the multiple tags 60 (e.g., along a line-of-sight between the multiple tags 60 and one or more readers 64 (e.g., anchors) in the environment 10) and/or may be formed without certain materials (e.g., conductive materials, such as metal) to overlay the multiple tags 60.

The one or more readers 64 may be configured to receive RF signals from the multiple tags 60. For example, the one or more readers 64 may be UWB readers (e.g., capable of receiving a UWB signal). In an embodiment, the one or more readers 64 include multiple readers 64 distributed about the environment 10, such as mounted to a fixed structure of the environment 10, such as mounted to the stage ceiling 22 and/or the stage floor 24. In an embodiment, the multiple tags 60 include active tags that each emit a respective UWB signal (e.g., with a respective tag identifier), which is received at the one or more readers 64. In an embodiment, the multiple tags 60 include passive tags that provide the respective UWB signal as passive backscatter. For example, the one or more readers 64 may send an initial UWB signal to the multiple tags 60, which may receive the initial UWB signal and generate passive backscatter, which is received at the one or more readers 64. While the active tags may enable efficient, precise tracking of a position (e.g., position data; current position) of the animated FIG. 12, the passive tags may enable tracking of the position of the animated FIG. 12 without a power supply for the multiple tags 60 at the animated FIG. 12 (e.g., power for the multiple tags 60 is external to the animated FIG. 12, and power for the multiple tags 60 may be achieved via power harvesting circuitry on the animate FIG. 12, wherein the power harvesting circuitry converts electromagnetic energy into direct current voltage, such as the initial UWB signal into direct current voltage).

Together, the multiple tags 60 and the one or more readers 64 may be part of a tracking system 68 that operates to determine the position for the animated figure, wherein the position for the animated figure includes location and orientation (e.g., three-dimensional position, including x, y, and z coordinates). In particular, the multiple tags 60 and the one or more readers 64 may be part of the tracking system 68, which operates as a real-time locating system that performs continuous location tracking (e.g., position and/or orientation tracking; movement over time) of the animated FIG. 12 within the environment 10. Further, the tracking system 68 may operate to process respective signals from the one or more readers 64 to determine the position for the animated FIG. 12 over time, wherein the position for the animated FIG. 12 over time reflects or indicates movement of the animated FIG. 12. As noted herein, “the position” for the animated FIG. 12 may refer to the location, the orientation, and/or the movement of the animated FIG. 12. Further, “the position” for the animated FIG. 12 may generally indicate a pose for the animated FIG. 12 and/or changes to the pose for the animated FIG. 12. Thus, in operation, the projector 16 may project the imagery 14 onto the animated FIG. 12 in synchronization with an actual, current position (e.g., pose) of the animated FIG. 12 based on the signals from the one or more readers 64, and without relying on position, velocity, and/or acceleration information from devices, such as sensors and/or actuators, coupled to the animated FIG. 12. However, it should be appreciated that in some embodiments, the media control system 20 may verify the position of the animated FIG. 12 based on position, velocity, and/or acceleration information from devices, such as sensors and/or actuators, coupled to the animated FIG. 12.

It should be understood that the projection mapping system 8 may have any of a variety of components and configurations. For example, the projection mapping system 8 may include any suitable number of projectors 16, tags 60, and/or readers 64. In an embodiment, more than one animated FIG. 12 may be included within the environment 10, and the projection mapping system 8 may include at least one projector 16 for each animated FIG. 12. In an embodiment, multiple projectors 16 may be provided to deliver the imagery 14 to multiple sides of a single animated FIG. 12. Further, in an embodiment, the projector 16 and the one or more readers 64 may be physically coupled to one another. For example, the projector 16 and the one or more readers 64 may be rigidly mounted to a fixed structure of the environment 10, such as mounted to the stage ceiling 22, the stage floor 24, or a show set frame, to form a unified system so that the projector 16 and the one or more readers 64 remain in fixed positions relative to one another (e.g., with a known offset). The unified system may simplify a calibration of the media control system 20 and the tracking system 68. Further, the unified system blocks (e.g., reduces or eliminates) an amount of drift between the projector 16 and the one or more readers 64 during operation of the projection mapping system 8 in the environment 10.

Regardless of how the projector 16 and the one or more readers 64 are positioned within the environment 10, the calibration is performed to establish a relationship between the projector 16 of the media control system 20 and the one or more readers 64 of the tracking system 68 to enable the projector 16 to project the imagery 14 onto the animated FIG. 12 that is tracked via the one or more readers 64. The calibration may occur prior to operation of the environment 10 as an attraction. For example, the calibration may occur before the week begins, each day before opening, before each cycle of the environment 10, or any combination thereof. In an embodiment, the calibration may occur (e.g., be triggered) by a big movement of the animated FIG. 12 (e.g., a threshold distance across the show set).

FIG. 1 also illustrates an example of an interactive data source 70 that includes one or more guest sensors 72. The one or more guest sensors 72 may collect guest input from any of the one or more guests 34 within the guest area 32. As recognized herein, the guest input is one form of interactive data that may be utilized to adaptively update the animated FIG. 12 and/or the environment 10. For example, the motion control system 50 may generate a response for the animated FIG. 12 to perform based on the interactive data, and then instruct actuators of the animated FIG. 12 to perform the response.

In an embodiment, the animated FIG. 12 may also include or be coupled to one or more trackers 74 (e.g., light emitting or light reflecting trackers; visible or non-visible; active or passive; retro-reflective markers or active light emitters; array of trackers; detectable patterns). The one or more trackers 74 provide discrete points on the animated FIG. 12 that may be used directly as visual reference points, on which to base or to supplement calibration and/or determination of the position of the animated FIG. 12. For example, the calibration is performed to establish a relationship between the projector 16 of the media control system 20, the one or more readers 64 of the tracking system 68, and the one or more tracking cameras 76. Then, the one or more trackers 74 may be detected by one or more tracking cameras 76, which may generate image data that may be analyzed to identify the one or more trackers 74 to supplement and/or to confirm the determination of the position of the animated FIG. 12. In an embodiment, the one or more trackers 74 may be detected by one or more tracking cameras 76 to supplement and/or to confirm the determination of the position of the animated FIG. 12 (e.g., to provide an additional position indicator) continuously or periodically, such as before the week begins, each day before opening, before each cycle of the environment 10, upon a big movement of the animated FIG. 12, or any combination thereof.

In one embodiment, the animated FIG. 12 may be coated with a unique pattern, (such as that of facial features imprinted or embedded). For example, the unique pattern may be made up of both infrared reflective and infrared absorbent pigments of a same visible base color, which causes a uniform looking surface in the visible light spectrum (which is best for projecting colored light imagery). However, as viewed through one or more tracking cameras 76, the unique pattern would be highly visible and trackable. This use of specialized pigments improves detection of the unique pattern in the presence of projected visible light and/or reduces processing utilized to identify the unique pattern in the presence of projected visible light.

In an embodiment, the use of the one or more trackers 74 and/or the one or more tracking cameras 76 may also facilitate calibration and/or detection of maintenance events. For example, over time, the animated FIG. 12 may experience surface alterations, such as sagging of the external surface 40 relative to other components of the animated FIG. 12, including relative to the multiple tags 60 included in the animated FIG. 12. More particularly, the external surface 40 may be wrapped around an internal frame of the animated FIG. 12, and the multiple tags 60 may be supported on (e.g., mounted on) the internal frame of the animated FIG. 12. However, over time, the external surface 40, which may be a polymer material (e.g., plastic, elastomer, rubber), may shift (e.g., stretch, sag) relative to the internal frame of the animated FIG. 12, and thus, relative to the multiple tags 60 that are supported on the internal frame of the animated FIG. 12. In an embodiment, the shift of the external surface 40 may include a change from an initial placement of the external surface 40 relative to the internal frame of the animated FIG. 12, wherein the change is not due to actuation of the animated FIG. 12 (e.g., not only during the actuation of the animated FIG. 12; the change exists in a rest or baseline position of the animated FIG. 12). Accordingly, there may be a mismatch between the position of the external surface 40 as calculated based on detection of the multiple tags 60 by the one or more readers 64, and an actual position of the external surface 40 of the animated FIG. 12 in some instances (e.g., over time; at the rest or baseline position of the animated FIG. 12; and/or in some or all positions of the animated FIG. 12, such as in some or all orientations, in some or all locations, and/or during some or all movements).

However, because the one or more trackers 74 may be coupled to (e.g., embedded in, mounted on) the external surface 40, the one or more trackers 74 may shift with the external surface 40. Accordingly, if tracking data generated by the one or more tracking cameras 76 based on detection of the one or more trackers 74 indicates the shift of the external surface 40 relative to the internal frame of the animated FIG. 12, the projection mapping system 8 may reset (e.g., recalculate, derive) the known position (e.g., the known arrangement) of the multiple tags 60 relative to the body 42 of the animated FIG. 12, and then may continue to accurately track the position of the animated FIG. 12 based on the signals generated by the one or more readers 64. Additionally or alternatively, if tracking data generated by the one or more tracking cameras 76 based on detection of the one or more trackers 74 indicates the shift of the external surface 40 relative to the internal frame of the animated FIG. 12, the projection mapping system 8 may provide a maintenance alert, such as a notification to an operator to perform maintenance operations. For example, the maintenance operations may include adjusting the external surface 40 and/or performing a recalibration process (e.g., based on and to account for a change in a relationship between the external surface 40 and the multiple tags 60).

In an embodiment, at least one or more of the multiple tags 60 (e.g., one or more additional tags; one or more surface tags) may be utilized to facilitate calibration and/or detection of maintenance events in a similar manner as described herein for the one or more trackers 74 and/or the one or more tracking cameras 76. In an embodiment, both the at least one or more of the multiple tags 60 and the one or more trackers 74 may utilized for such purposes, such as coupled to the external surface 40 to enable detection of shift of the external surface 40, for example. It should be appreciated that, in an embodiment, the projection mapping system 8 may be devoid of any trackers (e.g., light emitting trackers, light reflecting trackers) and devoid of any tracking cameras, or at least the projection mapping system 8 does not use inputs of any trackers from any tracking cameras to determine the position of the animated FIG. 12 or to confirm the position of the animated FIG. 12 (e.g., to periodically check, verify, or confirm). Indeed, the projection mapping system 8 may be devoid of any cameras, or at least the projection mapping system 8 may not use inputs of any images from any cameras to determine the position of the animated FIG. 12 or to confirm the position of the animated FIG. 12.

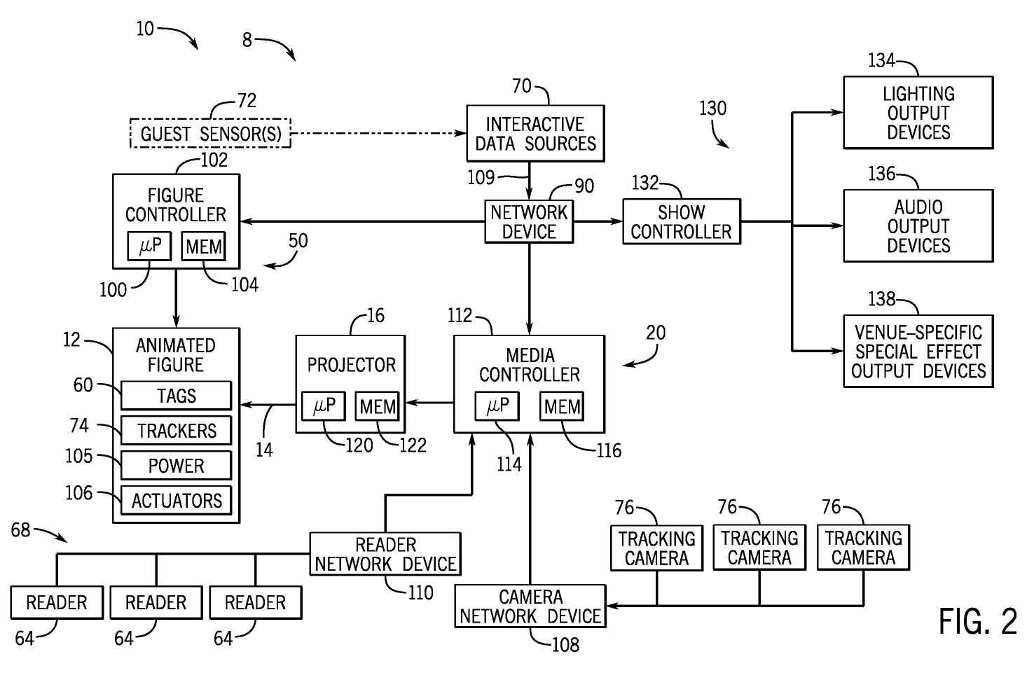

FIG. 2 is a block diagram of the projection mapping system 8 having the media control system 20 that may operate to externally project images onto the animated FIG. 12 (e.g., without communicatively coupling to or relying exclusively on the motion control system 50). In an embodiment, the media control system 20 may not directly transmit to or receive communication signals from the motion control system 50. However, as discussed herein, the interactive data sources 70 may be communicatively coupled upstream of both the media control system 20 and the motion control system 50 to enable coordination of the media control system 20 and the motion control system 50, without intercommunication between the systems 20, 50. A network device 90, such as a switch or a hub, may be communicatively coupled directly downstream of the interactive data sources 70 to facilitate efficient communications between the interactive data sources 70 and the systems 20, 50. However, it should be understood that the network device 90 may be omitted, that multiple network devices 90 may be implemented, or that any other suitable data management device may be utilized to facilitate delivery of data from the interactive data sources 70 to the systems 20, 50.

In an embodiment, the motion control system 50 includes a figure processor 100 and a figure memory 104, which may collectively form all or a portion of a figure controller 102. The figure processor 100 and the figure memory 104 may be on-board the animated FIG. 12 and/or in any other suitable location. The multiple tags 60 may be coupled to the body 42 (FIG. 1) of the animated FIG. 12 to enable the one or more readers 64 of the media control system 20 to generate the signals indicative of the position of the animated FIG. 12. Further, the one or more readers 64 may provide the signals indicative of the position of the animated FIG. 12 to a media controller 112 (e.g., processing system; computing system).

As shown, the animated FIG. 12 may also include the one or more trackers 74, which may be detectable via the one or more tracking cameras 76. For example, the one or more trackers 74 and the one or more tracking cameras 76 may facilitate identification of a maintenance event, such as a shift of the external surface 40 (FIG. 1) of the animated FIG. 12 relative to the multiple tags 60 coupled to the animated FIG. 12. The one or more tracking cameras 76 may be communicatively coupled to a camera network device 108, which relays signals indicative of the position of the animated FIG. 12 from the one or more tracking cameras 76 to the media controller 112. The camera network device 108 may be a network switch or hub that consolidates multiple streams of information from the one or more tracking cameras 76 for efficient processing by the media controller 112.

Further, as shown, the animated FIG. 12 may be fitted with a power supply 105 (e.g., power storage, such as a battery; cable power supply) and/or any suitable actuators 106 that enable the animated FIG. 12 to move (e.g., ambulate, translate, rotate, pivot, lip synchronize) in a realistic and life-emulating manner. For example, the actuators 106 may operate to drive one portion of the animated FIG. 12 relative to another portion of the animated FIG. 12. The interactive data sources 70 may include any suitable data source that provides a variable set of data over time as interactive data 109. For example, the one or more guest sensors 72 may sense guest interactions and relay interactive data indicative of the guest interactions to the figure controller 102. Then, the figure controller 102 may instruct the actuators 106 to dynamically manipulate the animated FIG. 12 to respond to the interactive data 109.

The media control system 20 may include the projector 16 and/or the media controller 112. The media controller 112 is communicatively coupled to the interactive data sources 70 (e.g., via the network device 90), thereby enabling the media controller 112 to dynamically react to the interactive data 109 and/or to other changes in the environment 10. In an embodiment, the media control system 20 may be communicatively isolated from the motion control system 50. That is, the motion control system 50 may be independent from the media control system 20. Thus, the media control system 20 provides operational freedom to the animated FIG. 12 to adaptively respond to the interactive data 109 in substantially real-time (e.g., within microseconds or milliseconds of an interaction), while the media control system 20 monitors or traces movements of the animated FIG. 12 to project images thereon also in substantially real-time. As such, while the motion control system 50 performs a figure feedback loop, the media control system 20 simultaneously performs a media feedback loop that modifies the imagery 14 projected onto the animated FIG. 12.

To gather information regarding a position of the animated FIG. 12, the media control system 20 leverages the one or more readers 64 of the tracking system 68. A type or configuration of the one or more readers 64 may be individually selected to detect a type of the multiple tags 60. The position of the multiple tags 60, in conjunction with geometric or skeletal models of the animated FIG. 12, facilitates coordination of projection onto the animated FIG. 12 in different positions and orientations, and during different movements.

The one or more readers 64 are communicatively coupled to a reader network device 110, which relays signals indicative of the position (e.g., current three-dimensional position; orientation; position data; including x, y, and z coordinates relative to a shared origin) of the animated FIG. 12 (e.g., an entirety of the animated FIG. 12 or portions thereof; a pose of the animated FIG. 12) to the media controller 112. The reader network device 110 may be a network switch or hub that consolidates multiple streams of information from the one or more readers 64 for efficient processing by the media controller 112. In an embodiment, the media controller 112 includes a media processor 114 and a media memory 116, which operate together to determine, generate, and/or adjust the imagery 14 to be projected onto the animated FIG. 12 based on the position of the animated FIG. 12. Then, the media controller 112 may instruct the projector 16 to project the imagery 14 in a dynamic manner onto the animated FIG. 12. The imagery 14 may be wholly rendered on demand based on a current pose (e.g., position and orientation) of the animated FIG. 12. In less complex configurations, the imagery 14 may be generated by adapting a prerecorded video stream to the current pose of the animated FIG. 12. The media controller 112 may be any suitable media generator or game engine with significant processing power and reduced latency. It should be understood that the media controller 112 is therefore capable of generating the imagery 14 to be projected onto the animated FIG. 12 in substantially real-time, based on the data received from the one or more readers 64. Indeed, the media controller 112 may maintain a skeletal model or algorithm that represents the animated FIG. 12 and its actuatable portions (e.g., jaw, limbs, joints). Based on the data, the media controller 112 may update the skeletal model to represent an actual, current position of the animated FIG. 12, and then generate the imagery 14 to be projected onto the animated FIG. 12 having the current position.

The projector 16 may include a projector processor 120 and a projector memory 122 to facilitate the presentation of the imagery 14 onto the animated FIG. 12. The projector processor 120 generally receives data indicative of the imagery 14 from the media controller 112, and then instructs a light source within the projector 16 to output the imagery 14 through a lens. The projector 16 may be moveable or actuatable to follow and align with the animated FIG. 12, such as based on commands received from the media controller 112. Alternatively, the projector 16 may be stationary. In any case, the media controller 112 may determine a current silhouette or a shape of a target figure portion of the animated FIG. 12 that is to receive the imagery 14 based on the updated skeletal model, and then instruct the projector 16 to provide the imagery 14 onto the silhouette.

The figure processor 100, media processor 114, and projector processor 120 are each any suitable processor that can execute instructions for carrying out the presently disclosed techniques, such as a general-purpose processor, system-on-chip (SoC) device, an application-specific integrated circuit (ASIC), a processor of a programmable logic controller (PLC), a processor of an industrial PC (IPC), or some other similar processor configuration. These instructions are encoded in programs or code stored in a tangible, non-transitory, computer-readable medium, such as the figure memory 104, media memory 116, and projector memory122, and/or other storage circuitry or device. As such, the figure processor 100 is communicatively coupled to the figure memory 104, the media processor 114 is communicatively coupled to the media memory 116, and the projector processor 120 is communicatively coupled to the projector memory 122. In an embodiment, the projection mapping system 8 may also include a show control system 130 that coordinates additional output devices of the environment 10. For example, a show controller 132 of the show control system 130 is communicatively coupled between the network device 90 and one or multiple lighting output devices 134, audio output devices 136, and/or venue-specific special effect output devices 138 (e.g., fog machines, vibration generators, actuatable portions of the scenery objects 26 of FIG. 1).

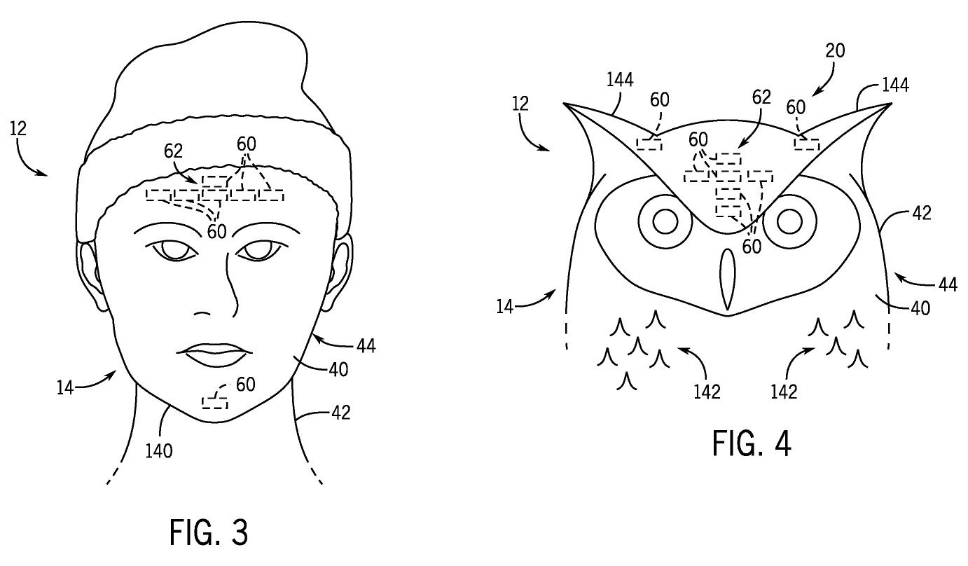

FIG. 3 is a front view of an example of the imagery 14 provided onto the head portion 44 of the body 42 of the animated FIG. 12. In an embodiment, the imagery 14 may include features or textures that resemble a face. For example, eyebrows, eyes, a nose, lips, and/or wrinkles may be components of the imagery 14 projected onto the head portion 44. In an embodiment, the animated FIG. 12 is outfitted with a costume element (e.g., a hat, wig, jewelry), and the media controller 112 (FIG. 2) and/or the projector 16 (FIGS. 1 and 2) may identify an outline of the external surface 40 of the animated FIG. 12 formed by the costume element via techniques disclosed herein. Then, the projector 16 (FIGS. 1 and 2) directs the imagery 14 to a target portion or figure portion of the external surface 40 of the animated FIG. 12. The media control system 20 (FIGS. 1 and 2) may monitor movement of the animated FIG. 12, such as large movements across the stage and/or small movements of an articulating portion 140 (e.g., that articulates or moves relative to another portion of the animated FIG. 12, such as an articulating jaw that move relative to a remainder of the head portion 44), based on detection of the multiple tags 60, as described herein. Then, the media control system 20 may project appropriate, realistic imagery 14 onto the head portion 44 of the animated FIG. 12 in coordination (e.g., during) the movement of the animated FIG. 12.

FIG. 4 is a front view of an example of the imagery 14 provided onto the head portion 44 of the body 42 of the animated FIG. 12. As illustrated, the imagery 14 may provide the animated FIG. 12 with a character, non-human, and/or fanciful appearance, such as the appearance of an owl. In an embodiment, the external surface 40 of the head portion 44 may be textured and/or have a unique pattern 142 to complement the imagery 14 and/or facilitate certain tracking techniques, as described herein. It should also be understood that the imagery 14 may also include any of a variety of supernatural, fanciful, and/or non-human images and/or effects, such as flames, smoke, shapeshifting, color morphing, and so forth. The media control system 20 (FIGS. 1 and 2) may monitor movement of the animated FIG. 12, such as large movements across the stage and/or small movements of an articulating portion 144 (e.g., articulating ears that move relative to a remainder of the head portion 44), based on detection of the multiple tags 60, as described herein. Then, the media control system 20 may project appropriate, realistic imagery 14 onto the head portion 44 of the animated FIG. 12 in coordination (e.g., during) the movement of the animated FIG. 12.

As shown in FIGS. 3 and 4, the multiple tags 60 may be arranged in the tag array 62, such as with the multiple tags 60 spaced apart from one another in a known configuration relative to one another. In addition, the multiple tags 60 are in a known arrangement relative to the body 42 of the animated FIG. 12 (e.g., relative to the external surface 40, which receives and/or displays the imagery 14). Accordingly, each of the multiple tags 60 (and its respective unique tag identifier) is associated with a known position within the animated FIG. 12 as part of the known configuration of the tag array 62, as well as the known arrangement relative to the body 42 of the animated FIG. 12.

Additionally, with reference to FIGS. 3 and 4, the multiple tags 60 may be enclosed within the body 42 of the animated FIG. 12, such that the multiple tags 60 are not visible to the one or more guests 34 (e.g., FIG. 1; not visible through the external surface 40 of the animated FIG. 12; hidden from view by the external surface 40 of the animated FIG. 12). As described herein, the body 42 of the animated FIG. 12 may be formed with certain materials (e.g., non-conductive materials, such as elastomer; flexible skin) to overlay the multiple tags 60 (e.g., along a line-of-sight between the multiple tags 60 and one or more readers 64 (FIGS. 1 and 2) in the environment 10) and/or may be formed without certain materials (e.g., conductive materials, such as metal) to overlay the multiple tags 60. For example, in FIGS. 3 and 4, the multiple tags 60 are positioned behind (e.g., relative to a perspective of the one or more guests 34) the external surface 40, which may be formed from non-conductive elastomer to provide an appearance of flexible skin for the animated FIG. 12. In this way, the multiple tags 60 are not visible to the one or more guests 34, but are also able to communicate with (e.g., be detectable by) the one or more readers 64.

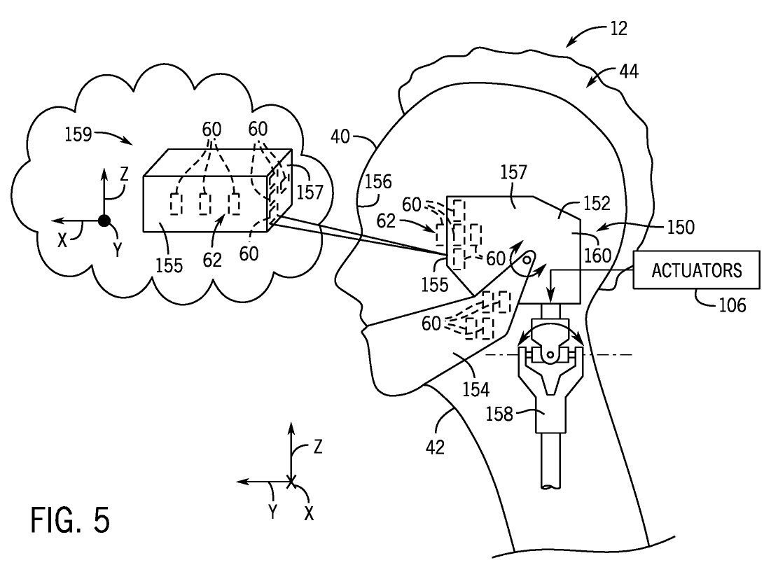

FIG. 5 is a cross-sectional schematic side view of an embodiment of a portion of the animated FIG. 12 with the multiple tags 60 arranged in the tag array 62. As shown, the portion of the animated FIG. 12 includes the head portion 44 of the body 42 of the animated FIG. 12. An internal frame 150 (e.g., rigid frame; structural support) supports the multiple tags 60 arranged in the tag array 62, as well as the external surface 40 onto which the projector 16 (FIGS. 1 and 2) projects the imagery 14 (FIGS. 1-4). For example, the internal frame 150 may include a first frame portion 152 (e.g., main frame) and a second frame portion 154 (e.g., articulating portion) that moves relative to the first frame portion 152. In an embodiment, an outer wall 156 (e.g., molded shell) is coupled to the internal frame 150, such as to the first frame portion 152. The outer wall 156 may wrap around and enclose the internal frame 150, as well as the multiple tags 60 arranged in the tag array 62. Further, the outer wall 156 may provide the external surface 40.

In an embodiment, the outer wall 156 may be formed with certain materials (e.g., non-conductive materials, such as elastomer; flexible skin) to overlay the multiple tags 60 and/or may be formed without certain materials (e.g., conductive materials, such as metal) to overlay the multiple tags 60. For example, in FIG. 5, the multiple tags 60 are positioned behind (e.g., relative to a perspective of the one or more guests 34 (FIG. 1)) the external surface 40, which may be formed from non-conductive elastomer to provide an appearance of flexible skin for the animated FIG. 12. In this way, the multiple tags 60 are not visible to the one or more guests 34, but are also able to communicate with (e.g., be detectable by) the one or more readers 64 (FIGS. 1 and 2). In an embodiment, the internal frame 150, or portions thereof, may be formed from any of a variety of materials to provide strength and also to enable communication between the one or more tags 60 and the one or more readers 64 (e.g., without interference due to conductive materials of the internal frame 150; without conductive materials along a line of sight between the one or more tags 60 and the one or more readers 64). For example, the first frame portion 152 may include a metal stem 158 a plastic bracket 160, wherein the metal stem 158 is positioned to provide support from below (e.g., relative to a gravity vector) the plastic bracket 160, and the one or more tags are mounted on (e.g., fastened to) the plastic bracket 160.

As shown in FIG. 5, the multiple tags 60 of the tag array 62 may include respective tag(s) 60 coupled to various portions of the internal frame 150. For example, in an embodiment, one or more tag of the multiple tags 60 (e.g., a first set of the multiple tags 60; a first portion of the tag array 62; a first array) may be coupled to the first frame portion 152, and one or more tag of the tags 60 (e.g., a second set of the multiple tags 60; a second portion of the tag array 62; a second array) may be coupled to the second frame portion 154. In this way, the multiple tags 60 enable tracking respective positions of both the first frame portion 152 and the second frame portion 154, when the second frame portion 154 articulates relative to the first frame portion 152 (e.g., via the actuators 106; tracking without inputs from devices on the animated FIG. 12, such as without inputs from the actuators 106 or sensors associated with the actuators 106).

In FIG. 5, the multiple tags 60 that are coupled to the first frame portion 152 are arranged in rows and columns that extend in three dimensions (e.g., respective stack of some of the multiple tags 60 along an x-axis, respective stack of some of the multiple tags along a y-axis, and respective stack of some of the multiple tags along a z-axis). For example, a first surface 155 of the main frame 152 may extend in a plane along or parallel to the x-axis and may support the respective stack of some of the multiple tags 60 along the x-axis. While a second surface 157 of the main frame 152 may extend in another plane along or parallel to the y-axis and may support the respective stack of some of the multiple tags 60 along the y-axis and the respective stack of some of the multiple tags along the z-axis. Indeed, an inset 159 in FIG. 5 illustrates one non-limiting example of how the multiple tags 60 may be coupled to the first frame portion 152 in rows and columns that extend in three dimensions. Further, to illustrate that either two-dimension arrangements, three-dimension arrangements, or combinations thereof are envisioned, the multiple tags 60 coupled to the second frame portion 154 are shown to extend in two dimensions (e.g., respective stack of some of the multiple tags along a y-axis, and respective stack of some of the multiple tags along a z-axis).

As set forth herein, the multiple tags 60 are in the known configuration relative to one another and in the known arrangement relative to the internal frame 150 and the external surface 40 of the animated FIG. 12 (e.g., at least during a rest or baseline position of the animated FIG. 12). Thus, tracking the multiple tags 60 with the one or more readers 64 provides position data that enables updates to the skeletal model of the animated FIG. 12, which may then enable projection of imagery 14 (FIGS. 1-4) that precisely suits the position of the animated FIG. 12, or portions thereof. It should be appreciated that the known configuration may include all of the multiple tags 60 coupled to both the first frame portion 152 and the second frame portion 152, which may move relative to one another. For example, the known configuration may include relative positions of the one or more tags 60 of the multiple tags 60 (e.g., the first set of the multiple tags 60) coupled to the first frame portion 152, and the one or more tags 60 of the multiple tags 60 (e.g., the second set of the multiple tags 60) coupled to the second frame portion 154 (e.g., at least during a rest or baseline position of the animated FIG. 12) to facilitate tracking the animated FIG. 12 as a whole. However, in an embodiment, respective known positions are established for each set of multiple tags 60, such as separately for the one or more of the multiple tags 60 (e.g., the first set of the multiple tags 60) coupled to the first frame portion 152 and separately for the one or more tags 60 of the multiple tags 60 (e.g., the second set of the multiple tags 60) coupled to the second frame portion 154 to facilitate separately tracking different portions of the animated FIG. 12 (e.g., the first frame portion and the second frame portion 154, which may move relative to one another) in order to track the position of the animated FIG. 12 and to update the skeletal model and/or generate the imagery 14, for example.

As shown, the animated FIG. 12 may also include the one or more trackers 74 (FIGS. 1 and 2), which may be detectable via the one or more tracking cameras 76 (FIGS. 1 and 2). For example, the one or more trackers 74 and the one or more tracking cameras 76 may facilitate identification of a maintenance event, such as a shift of the external surface 40 (FIG. 1) of the animated FIG. 12 relative to the multiple tags 60 coupled to the animated FIG. 12.

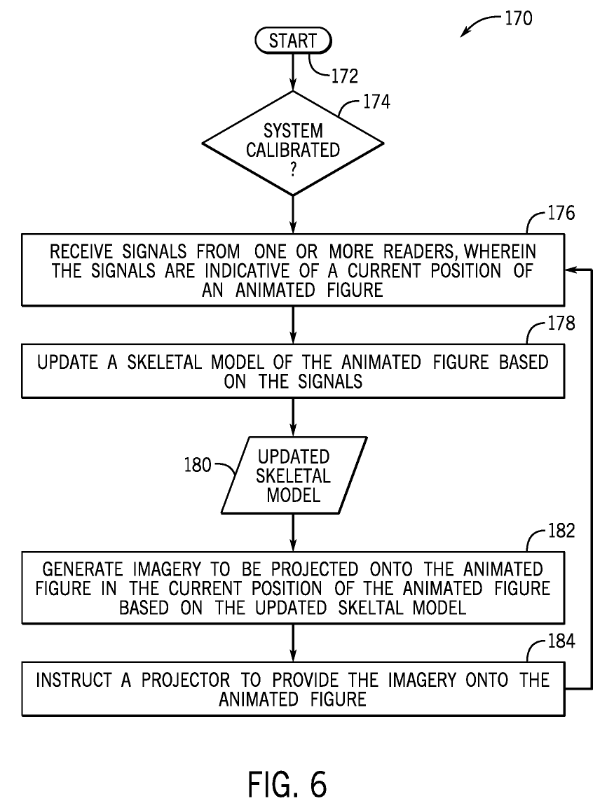

FIG. 6 is a flow diagram of a method 170 of operating a projection mapping system, such as the projection mapping system 8 of FIG. 1, in accordance with an embodiment of the present disclosure. The method 170 disclosed herein includes various steps represented by blocks. It should be noted that at least some of the blocks of the method 170 may be performed as an automated procedure, such as via the media controller 112 of FIG. 2. Although the flow diagram illustrates the blocks in a certain sequence, it should be understood that the blocks may be performed in any suitable order and certain blocks may be carried out simultaneously, where appropriate. Further, certain blocks may be omitted and/or other blocks may be added.

The method 170 initiates at block 172. At block 174, a media controller may determine whether the projection mapping system is calibrated. For example, a projector of a projection system and one or more readers of a tracking system are initially calibrated to a shared coordinate system with a shared origin point in an environment. In an embodiment with one or more tracking cameras, the one or more tracking cameras may also be calibrated to the shared coordinate system with the shared origin point in the environment. Any of a variety of calibration techniques may be employed to align and calibrate the projector, the one or more readers, and/or the one or more tracking cameras in this manner. Additionally, multiple tags of a tag array may be initially calibrated to an animated character, including respective positions of the multiple tags relative to an external surface of the animated character. Further, when present, one or more trackers may also be calibrated to the animated character in a similar manner.

Thus, as set forth in block 174, at certain times (e.g., continuously or periodically, such as before the week begins, each day before opening, before each cycle of the environment, upon a big movement of the animated figure, or any combination thereof), the media controller may confirm that the projection mapping system is calibrated. For example, the projection mapping system may compare signals indicative of the position of the animated figure from the one or more readers to images indicative of the position of the animated figure from the one or more tracking cameras. Upon identifying a mismatch in the signals and the images (e.g., indicative different positions), the projection mapping system may determine that the projection mapping system is not calibrated. If the projection mapping system is not calibrated, the projection mapping system may re-calibrate, such as via any suitable technique described herein. It should be appreciated that the projection mapping system may utilize any of a variety of inputs to determine whether the projection mapping system is calibrated. For example, the projection mapping system may analyze images captured by one or more additional cameras to identify that the imagery is not accurately aligned with the external surface of the animated character to determine that the projection mapping system is not calibrated.

If the projection mapping calibration system is calibrated, at block 176 the media controller may receive signals from the one or more readers, wherein the signals are indicative of the position (e.g., current pose) of the animated figure. As noted above, the animated figure includes the multiple tags, and the one or more readers may receive RF signals (e.g., UWB signals) from the multiple tags. The RF signals may be analyzed (e.g., via time of flight) to determine the position of the animated figure. By identifying the multiple tags via the one or more readers, the media controller may identify the position of the actuatable object, without receiving or relying on position, velocity, and/or acceleration information from devices, such as sensors and/or actuators, of the animated figure. However, as noted previously, in some embodiments the media controller may combine inputs received from such devices with the signals received from the one or more readers and/or with the images received from the one or more tracking cameras to identify the position of the animated figure.

The media controller may determine position, as well as velocity and/or acceleration information, based on the signals from the one or more readers. In an embodiment, the media controller may leverage this information to estimate (e.g., predict) one or more future actions (e.g., interactive response) of the animated figure, thereby according a lead-time to the media controller for generating the imagery. The media controller operating predictively may generate corresponding imagery, wherein each image (e.g., projected content) of the corresponding imagery corresponds to a particular estimated future action of the one or more estimated future actions of the animated figure. Then, the media controller may select a particular generated image of the corresponding imagery, enabling the media control system to instantaneously provide appropriate images (e.g., textures) when a given course of action of the animated figure is realized.

At block 178, the media controller updates a skeletal model of the animated figure based on the signals to output an updated skeletal model 180. The skeletal model may include any suitable data structure and/or statistical model maintained in the media controller to represent the animated figure (e.g., including moveable or actuatable portions of the animated figure), and the updated skeletal model 180 may represent the current position of the animated figure (e.g., including the movable or actuatable portions of the animated figure). As such, the media controller may continuously update the skeletal model 180 to represent the actual, current pose (e.g., position) of the animated figure.

At block 182, the media controller generates data indicative of the imagery to be projected onto the animated figure in the current position based on the updated skeletal model 180. In contrast to predetermined or canned images, the imagery is generated in-situ or in real time to particularly correspond to the current position of the animated figure. Additionally, the data indicative of the imagery and/or the current position of the animated figure may be stored in a media memory for a time period.

At block 184, the media controller additionally instructs the projector 16 to provide (e.g., contour map) the imagery onto the animated figure having the current position. As recognized herein, the media control system implements contour mapping or contour-focus mapping with the updated skeletal model 180 to direct the selectively designed imagery onto targeted portions of the animated figure in a lifelike manner. For example, the media controller may generate and instruct the projector to output the imagery that are tuned to the particular position of the animated figure, thereby generating a contour mapped set of textures that are precisely focused to the particular spatial positioning of the animated figure. As such, the components of the media control system cooperate to adaptively analyze the animated figure and dynamically fit the imagery onto an instantaneous pose of the animated figure, which may be reacting to the interactive data sources and/or interacting with the one or more guests at any given time. The media controller may therefore return to block 176 to continue receiving sensor signals and continue performing the method 170.

Moreover, the media control system may monitor degradation or changes to the animated figure, such as shifts in the external surface of the animated figure. For example, the media control system may perform health monitoring of the animated figure based on tracking the one or more trackers on the animated figure via the one or more tracking cameras. That is, if the signals from the one or more readers do not correspond to the images generated by the one or more trackers, the projection mapping system may generate a notification (e.g., alert) indicative of a maintenance event. In some cases, the projection mapping system may be designed to stop operation of the media control system and/or the motion control system in response to the determining that the signals from the one or more readers do not correspond to the images generated by the one or more trackers. In other cases, in response to determining that the performance of the animated figure is only marginally affected (e.g., deviation that is more than a first threshold and less than a second, higher threshold), the media controller may provide the notification and continue cycling through the method 170. In a non-limiting embodiment, the media control system may initiate the calibration process to attempt to address the perceived differences. Therefore, it should be understood that the present media control system may operate as a quality assessment tool that identifies, qualifies, alerts, and/or corrects performance of the projection mapping system and the animated figure over time.

As noted herein, the projection mapping system may implement any of a variety of calibration components and techniques. As one example, multiple retro-reflective dots (e.g., markers; 7, 8, 9, 10, or more) may be placed in the attraction (e.g., on walls or objects; on the prop, such as on the animated figure, such as the one or more trackers). As part of the calibration, the projector may scan across the raster (e.g., a light scan; across two-dimensional pixels that form the raster). An imaging sensor (e.g., camera) mounted to the projector may capture/generate an image of the attraction. When a pixel of light from the projector hits one of the retro-reflective dots, the imaging sensor detects a bright point, and thus, the image includes indications of the bright points. Based on the relative locations of all the bright points detected by the imaging sensor, the media controller may determine a respective location (e.g., coordinates) that correspond to each of the bright points. For example, a first bright point that is in an upper right of the image corresponds to a first retro-reflective dot on a ceiling (e.g., at a first known location/coordinates in the attraction), while a second bright point that is in a lower left of the image corresponds to a second retro-reflective dot on a floor (e.g., at a second known location/coordinates in the attraction). Advantageously, the imaging sensor does not need to be high resolution or well-aligned to the projector.

Based on image analysis, the media controller may determine a respective pixel that corresponds to each of the retro-reflective dots (and thus, links the respective pixel to the coordinates in the attraction). The data is provided to a reverse mapping algorithm that calculates a location of the projector relative to the retro-reflective dots (and thus, relative to the coordinates in the attraction/the coordinate system for the attraction).

Further, a shared origin point may be set to establish a coordinate system (e.g., 2D or 3D; relative coordinate system for the environment) that does not change during the cycle of the environment. Then, the one or more readers reference the origin point and the coordinate system to track the animated figure within the coordinate system. Additionally, the projector may also reference the origin point and the coordinate system to enable the projector to accurately project the images onto the animated figure during the cycle of the environment (e.g., at all times and in all poses). In this way, the one or more readers and the projector are calibrated and aligned with one another. In operation during the cycle of the environment, when the one or more readers detect that the animated figure is at a first set of coordinates, the media controller may then instruct the projector to project the image to the animated figure at the first set of coordinates. Because the one or more readers and the projector have been calibrated and aligned with one another, and the multiple tags of the tag array have the known arrangement relative to the external surface of the animated figure, the image is properly aligned and mapped onto the animated figure.

Various methods to conduct calibration and alignment of the one or more readers (e.g., tracking system) and the projectors (e.g., projection system) are envisioned. The methods may measure the relative position of the one or more readers of the motion tracking system and the environment, as well as the relative position of the projection lenses of the projectors and the environment. The methods may determine the relative position of the motion tracking system and the projection lens (e.g., establish a common origin and coordinate system).

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. A dynamic projection mapping system, comprising:
a projector configured to project visible light;
one or more radiofrequency (RF) readers configured to detect a plurality of RF tags of a prop;
a processing system comprising one or more processors; and
memory storing instructions that, when executed by the processing system, causes the processing system to:
determine a position of the prop in an environment based on signals received from the one or more RF readers based on detection of the plurality of RF tags; and
instruct the projector to provide the visible light onto the prop based on the position of the prop.

2. The dynamic projection mapping system of claim 1, wherein the one or more RF readers are configured to detect ultra-wideband (UWB) signals emitted or backscattered by the plurality of RF tags.

3. The dynamic projection mapping system of claim 1, comprising the prop with the plurality of RF tags, wherein the plurality of RF tags is configured to emit or backscatter ultra-wideband (UWB) signals.

4. The dynamic projection mapping system of claim 1, comprising the prop with the plurality of RF tags, wherein the plurality of RF tags are arranged in a two-dimensional array that extends along two axes or a three-dimensional array that extends along three axes.

5. The dynamic projection mapping system of claim 4, wherein the prop comprises an internal frame, and the plurality of RF tags are mounted in respective fixed positions on the internal frame.

6. The dynamic projection mapping system of claim 1, wherein the prop comprises an animated figure.

7. The dynamic projection mapping system of claim 6, wherein the instructions, when executed by the processing system, cause the processing system to instruct the projector to provide the visible light to present facial features onto an external surface of the animated figure based on the position of the animated figure.

8. The dynamic projection mapping system of claim 1, comprising:
one or more trackers exposed at an external surface of the prop; and
one or more tracking cameras configured to detect the one or more trackers;
wherein the instructions, when executed by the processing system, cause the processing system to:
determine an additional position indication for the prop in the environment based on additional signals received from the one or more tracking cameras based on detection of the one or more trackers; and
determine an occurrence of a maintenance event based on a comparison of the additional position indication and the position of the prop in the environment based on the signals received from the one or more RF readers.

9. The dynamic projection mapping system of claim 8, wherein the instructions, when executed by the processing system, cause the processing system to provide a notification indicative of the maintenance event.

10. The dynamic projection mapping system of claim 8, wherein the maintenance event comprises a shift in an external surface of the prop relative to the plurality of RF tags.

11. The dynamic projection mapping system of claim 1, wherein the instructions, when executed by the processing system, cause the processing system to establish a common coordinate system for the projector and the one or more RF readers.

12. The dynamic projection mapping system of claim 1, wherein the one or more RF readers are configured to generate signals indicative of the position of the prop relative to a common coordinate system, and the one or more processors are configured to instruct the projector to project the visible light to provide imagery onto the prop based on the position of the prop relative to the common coordinate system.

13. The dynamic projection mapping system of claim 1, wherein the position comprises a location and an orientation of the prop.

14. A dynamic projection mapping system, comprising:
a prop comprising a plurality of radiofrequency (RF) tags;
one or more RF readers configured to detect the plurality of RF tags;
a projector configured to project imagery;
a processing system comprising one or more processors; and
memory storing instructions that, when executed by the processing system, causes the processing system to:
determine a position of the prop relative to a common coordinate system for an environment based on signals received from the one or more RF readers based on detection of the plurality of RF tags; and
instruct the projector to project the imagery onto the prop based on the position of the prop relative to the common coordinate system for the environment.

15. The dynamic projection mapping system of claim 14, wherein the plurality of RF tags comprise a plurality of ultra-wideband (UWB) tags that transmit a unique identifier encoded in electromagnetic radiation, and the one or more RF readers comprise one or more UWB readers each at a respective fixed position in the environment and configured to receive the electromagnetic radiation.

16. The dynamic projection mapping system of claim 14, wherein the prop comprises:
an internal frame that supports the plurality of RF tags; and
an outer wall with an external surface to receive the imagery.

17. The dynamic projection mapping system of claim 16, wherein the outer wall covers the internal frame and the plurality of RF tags.

18. The dynamic projection mapping system of claim 14:
wherein one or more first RF tags of the plurality of RF tags are coupled to a first portion of an internal frame of the prop;
one or more second RF tags of the plurality of RF tags are coupled to a second portion of the internal frame of the prop; and
the first portion of the internal frame is configured to move relative to the second portion of the internal frame.

19. A method of operating a dynamic projection mapping system, the method comprising:
receiving, at one or more processors, signals from one or more ultra-wideband (UWB) readers based on detection of a plurality of UWB tags of a prop by the one or more UWB readers;
determining, using the one or more processors, a position of the prop in an environment based on the signals from the one or more UWB readers and known positioning of the one or more UWB readers in the environment; and
instructing, using the one or more processors, a projector to project imagery onto an external surface of the prop based on the position of the prop in the environment.

20. The method of claim 19, comprising:
determining, using the one or more processors, an updated position of the prop in the environment based on the signals from the one or more UWB readers; and
instructing, using the one or more processors, the projector to project the imagery onto the external surface of the prop based on the updated position of the prop in the environment.
